(19) United States
(12) Patent Application Publication
(10) Pub. No.: US 2022/0077790 A1
(43) Pub. Date: Mar. 10, 2022

(54) MULTI-OUTPUT POWER SUPPLY DEVICE

(71) Applicant: Yazaki Corporation, Tokyo (JP)

(72) Inventor: Satoshi ITO, Shizuoka (JP)

(73) Assignee: Yazaki Corporation, Tokyo (JP)

(21) Appl. No.: 17/411,169

(22) Filed: Aug. 25, 2021

(30) Foreign Application Priority Data
Sep. 8, 2020 (JP) 2020-150195

(51) Int. Cl. H02M 3/335; H02M 1/00; H02M 1/32

(52) U.S. Cl. CPC H02M 3/33592; H02M 3/33561; H02M 1/325; H02M 1/009; H02M 1/0003

(57) ABSTRACT

In a multi-output power supply device, a low-load main circuit supplies power to a low-voltage load portion from a main battery by employing at least one of batteries constituting a battery series body as the main battery. A low-load sub circuit supplies power to the low-voltage load portion from sub batteries by employing the batteries different from the main battery as the sub batteries out of the batteries constituting the battery series body. A flyback converter is a converter provided in the low-load sub circuit and capable of transforming a voltage. A controller controls driving of the flyback converter to supply power to the low-voltage load portion via the flyback converter from the sub batteries when the main battery is abnormal.

### CROSS-REFERENCE TO RELATED APPLICATION(S)

The present application claims priority to and incorporates by reference the entire contents of Japanese Patent Application No. 2020-150195 filed in Japan on Sep. 8, 2020.

### BACKGROUND OF THE INVENTION

### 1. Field of the Invention

The present invention relates to a multi-output power supply device.

### 2. Description of the Related Art

As a conventional multi-output power supply device, for example, Japanese Patent Application Laid-open No. H3-56040 discloses a power supply device capable of outputting a plurality of supply voltages. The power supply device supplies high-voltage power to a first load portion from all batteries of a battery series body in which the batteries are connected in series, and supplies low-voltage power to a second load portion from a battery of the battery series body.

Unfortunately, the power supply device disclosed in Japanese Patent Application Laid-open No. H3-56040 cannot supply power to the second load portion, for example, when the battery for the second load is abnormal. The power supply device has room for improvement on this point.

### SUMMARY OF THE INVENTION

The present invention has been made in view of the above problem, and an object thereof is to provide a multi-output power supply device capable of improving its reliability.

In order to solve the above mentioned problem and achieve the object, a multi-output power supply device according to one aspect of the present invention includes a battery series body in which a plurality of batteries are connected in series; a high-load main circuit configured to supply power to a high-voltage load portion from the battery series body; a low-load main circuit configured to supply power to a low-voltage load portion, a drive voltage of which is lower than the high-voltage load portion, from a main battery by employing at least one of the batteries constituting the battery series body as the main battery; a low-load sub circuit configured to supply power to the low-voltage load portion from a sub battery by employing a battery different from the main battery as the sub battery out of the batteries constituting the battery series body; a DC/DC converter provided in the low-load sub circuit and capable of transforming a voltage; and a controller configured to control the DC/DC converter, wherein the controller controls driving of the DC/DC converter to supply power to the low-voltage load portion via the DC/DC converter from the sub battery when the main battery is abnormal.

According to another aspect of the present invention, in the multi-output power supply device, it is preferable that a plurality of the DC/DC converters and a plurality of the sub batteries are provided, the DC/DC converters are provided corresponding to the respective sub batteries, and when the main battery is abnormal and some of the DC/DC converters are abnormal, the controller controls driving of the normal DC/DC converter to supply power to the low-voltage load portion via the normal DC/DC converter from the sub battery.

According to still another aspect of the present invention, in the multi-output power supply device, it is preferable that a plurality of the DC/DC converters and a plurality of the sub batteries are provided, the DC/DC converters are provided corresponding to the respective sub batteries, and when the main battery is abnormal, the controller controls driving of all the normal DC/DC converters to supply power to the low-voltage load portion via the respective DC/DC converters from the corresponding sub batteries, allowing the respective sub batteries to jointly supply power required for the low-voltage load portion.

According to still another aspect of the present invention, in the multi-output power supply device, it is preferable that the controller controls the DC/DC converter according to a normal mode in which the low-load main circuit supplies power to the low-voltage load portion by preferentially using the main battery when the low-load main circuit and the low-load sub circuit are normal, a sub battery power consumption mode in which the low-load sub circuit supplies power to the low-voltage load portion by preferentially using the sub battery when the low-load main circuit and the low-load sub circuit are normal, and an abnormal mode in which the low-load sub circuit supplies power to the low-voltage load portion when the low-load main circuit is abnormal and the low-load sub circuit is normal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of a multi-output power supply device according to an embodiment;

FIG. 2 is a block diagram illustrating an operation example (normal mode) of the multi-output power supply device according to the embodiment;

FIG. 3 is a block diagram illustrating an operation example (abnormal mode) of the multi-output power supply device according to the embodiment; and

FIG. 4 is a flowchart illustrating the operation example of the multi-output power supply device according to the embodiment.

### DETAILED DESCRIPTION OF THE PREFERRED EMBODIMENTS

Modes for carrying out the present invention (embodiments) will be described in detail with reference to the drawings. The contents described in the following embodiments are not intended to limit the present invention. Additionally, constituent elements in the following description include those easily arrived at by a person skilled in the art or those substantially the same as the constituent elements. Moreover, the constituent elements in the following description can be combined as appropriate, and various omissions, substitutions, or changes can be made therein without departing from the scope of the present invention.

### Embodiment

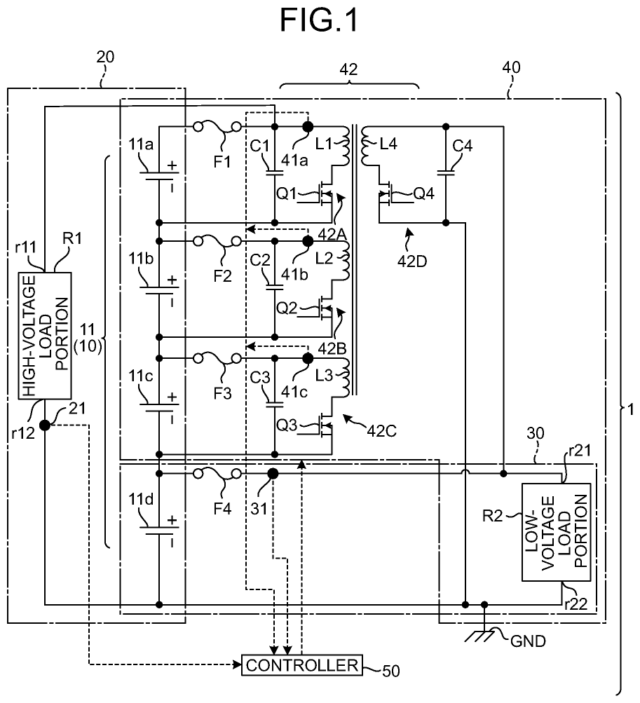

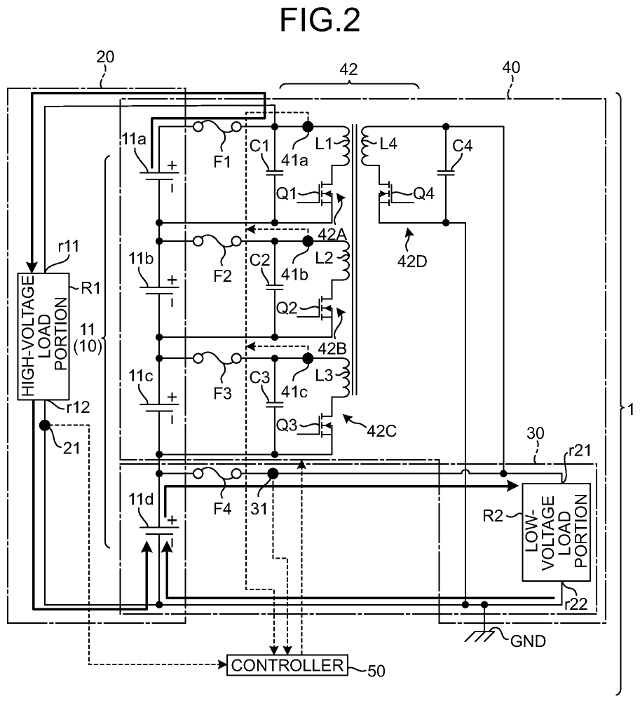

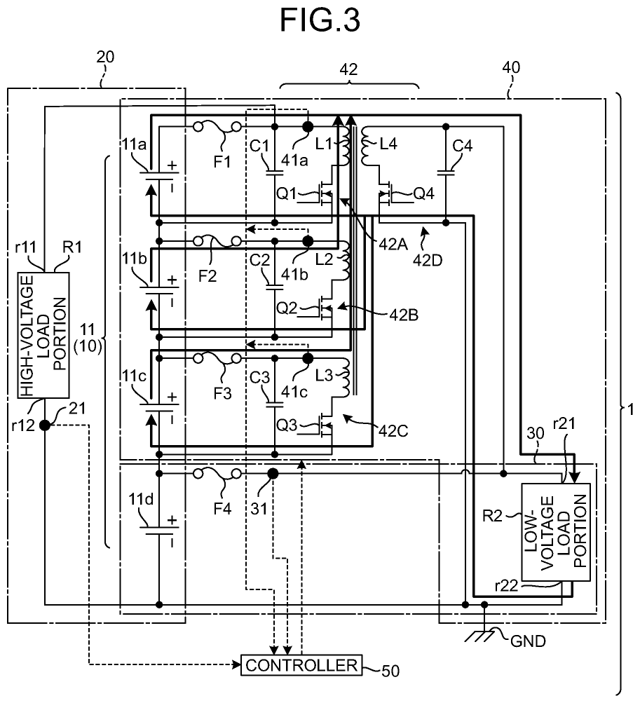

A multi-output power supply device 1 according to an embodiment will be described with reference to the drawings. FIG. 1 is a block diagram illustrating a configuration example of the multi-output power supply device 1 according to the embodiment. FIG. 2 is a block diagram illustrating an operation example (normal mode) of the multi-output power supply device 1 according to the embodiment. FIG. 3 is a block diagram illustrating an operation example (abnormal mode) of the multi-output power supply device 1 according to the embodiment.

The multi-output power supply device 1 is, for example, a multiple power supply device that is mounted in a vehicle to supply power to various load portions of the vehicle. Examples of the load portions mounted in the vehicle include a high-voltage load portion R1 using 48 V power, equivalent to electrical equipment such as an air conditioner, and a low-voltage load portion R2 using 12 V power, equivalent to a vehicle control ECU for controlling travelling of the vehicle, an automated driving ECU, mounted in the vehicle in the future, for controlling automated driving, or the like. The low-voltage load portion R2 is a load portion whose drive voltage is lower than the high-voltage load portion R1. The multi-output power supply device 1 supplies power to the high-voltage load portion R1 using 48 V power and the low-voltage load portion R2 using 12 V power. Hereinafter, the multi-output power supply device 1 will be described in detail.

As illustrated in FIG. 1, the multi-output power supply device 1 includes a battery series body 10, a high-load main circuit 20, a low-load main circuit 30, a low-load sub circuit 40, and a controller 50.

The battery series body 10 is obtained by connecting a plurality of batteries 11 in series. The batteries 11 can charge and discharge direct-current power, and are, for example, lithium-ion batteries. The batteries 11 are composed of, for instance, a plurality of batteries 11a to 11d, each of which has a voltage of about 12 V. The batteries 11a to 11d are connected in series with each other to constitute the battery series body 10. The battery series body 10 is connected to an external charger (not illustrated) to charge power supplied from the external charger. The battery series body 10 is also connected to the high-voltage load portion R1 using 48 V power. The battery series body 10 supplies power having a voltage of 48 V to the high-voltage load portion R1, for example, with a positive electrode terminal of the battery series body 10 connected to a first terminal r11 of the high-voltage load portion R1 and a negative electrode terminal of the battery series body 10 connected to a second terminal r12 of the high-voltage load portion R1. Each of the batteries 11a to 11d is provided with a Battery Management System (BMS), a Cell Voltage Sensor (CVS) or the like. The BMS or the CVS outputs detection values of a battery voltage, a battery current or the like to the controller 50.

The high-load main circuit 20 is a circuit that supplies power to the high-voltage load portion R1. The high-load main circuit 20 includes a current sensor 21, the high-voltage load portion R1, and the battery series body 10.

The current sensor 21 detects a current. For example, a Hall current sensor using a Hall element, or a shunt current sensor using a shunt resistor can be used as the current sensor 21. The current sensor 21 is disposed between the negative electrode terminal of the battery series body 10 and the second terminal r12 of the high-voltage load portion R1 to detect a current flowing between the negative electrode terminal of the battery series body 10 and the second terminal r12 of the high-voltage load portion R1. The current sensor 21 is connected to the controller 50 to output a current value of the detected current to the controller 50.

The high-voltage load portion R1 is the high-voltage load portion using 48 V power, equivalent to the electrical equipment such as an air conditioner as described above. The battery series body 10 is obtained by connecting the batteries 11a to 11d in series.

The high-load main circuit 20 supplies power having a voltage of 48 V to the high-voltage load portion R1 from the battery series body 10. In the high-load main circuit 20, a fuse F1 is disposed between the positive electrode terminal of the battery series body 10 and the first terminal r11 of the high-voltage load portion R1. The fuse F1 blows to protect the circuit when an overcurrent flows to the high-voltage load portion R1 from the battery series body 10.

The low-load main circuit 30 is a circuit that supplies power to the low-voltage load portion R2. The low-load main circuit 30 includes a current sensor 31, the low-voltage load portion R2, and the single battery (main battery) 11d. The low-load main circuit 30 is connected to a ground GND.

The current sensor 31 detects a current. For example, a Hall current sensor using a Hall element, or a shunt current sensor using a shunt resistor can be used as the current sensor 31. The current sensor 31 is disposed between a positive electrode terminal of the battery 11d and a first terminal r21 of the low-voltage load portion R2 to detect a current flowing between the positive electrode terminal of the battery 11d and the first terminal r21 of the low-voltage load portion R2. The current sensor 31 is connected to the controller 50 to output a current value of the detected current to the controller 50.

The low-voltage load portion R2 is the low-voltage load portion using 12 V power, equivalent to the vehicle control ECU, the automated driving ECU or the like as described above.

The low-load main circuit 30 employs at least one of the batteries 11a to 11d constituting the battery series body 10 as a main battery, and supplies power to the low-voltage load portion R2 from the main battery. In this embodiment, the low-load main circuit 30 employs the single battery 11d located at an end on the negative electrode side of the battery series body 10 as the main battery. In the following description, the battery 11d is sometimes referred to as the main battery 11d. The main battery 11d is connected to the low-voltage load portion R2 without using a flyback converter 42 described later. The main battery 11d supplies power having a voltage of 12 V to the low-voltage load portion R2, for example, with the positive electrode terminal of the main battery 11d connected to the first terminal r21 of the low-voltage load portion R2 and a negative electrode terminal of the main battery 11d connected to a second terminal r22 of the low-voltage load portion R2. In the low-load main circuit 30, a fuse F4 is disposed between the positive electrode terminal of the main battery 11d and the first terminal r21 of the low-voltage load portion R2. The fuse F4 blows to protect the circuit when an overcurrent flows to the low-voltage load portion R2 from the main battery 11d.

The low-load sub circuit 40 supplies power to the low-voltage load portion R2. The low-load sub circuit 40 includes current sensors 41a to 41c, smoothing capacitors C1 to C4, the low-voltage load portion R2, the three batteries (sub batteries) 11a to 11c, and the flyback converter 42.

The current sensors 41a to 41c detect a current. For example, a Hall current sensor using a Hall element, or a shunt current sensor using a shunt resistor can be used as the current sensors 41a to 41c. The current sensor 41a is disposed between a positive electrode terminal of the battery 11a and a coil L1 of a primary conversion unit 42A described later to detect a current flowing between the positive electrode terminal of the battery 11a and the coil L1 of the primary conversion unit 42A. The current sensor 41b is disposed between a positive electrode terminal of the battery 11b and a coil L2 of a primary conversion unit 42B described later to detect a current flowing between the positive electrode terminal of the battery 11b and the coil L2 of the primary conversion unit 42B. The current sensor 41c is disposed between a positive electrode terminal of the battery 11c and a coil L3 of a primary conversion unit 42C described later to detect a current flowing between the positive electrode terminal of the battery 11c and the coil L3 of the primary conversion unit 42C. The respective current sensors 41a to 41c are connected to the controller 50 to output current values of the detected currents to the controller 50.

The smoothing capacitors C1 to C4 smooth a current. The smoothing capacitor C1 is connected in parallel with the primary conversion unit 42A to smooth a current inputted into the primary conversion unit 42A. The smoothing capacitor C2 is connected in parallel with the primary conversion unit 42B to smooth a current inputted into the primary conversion unit 42B. The smoothing capacitor C3 is connected in parallel with the primary conversion unit 42C to smooth a current inputted into the primary conversion unit 42C. The smoothing capacitor C4 is connected in parallel with a secondary conversion unit 42D to smooth a current outputted from the secondary conversion unit 42D.

The low-load sub circuit 40 employs the batteries 11a to 11c different from the main battery 11d as sub batteries out of the batteries 11a to 11d constituting the battery series body 10, and supplies power to the low-voltage load portion R2 from the sub batteries. In this embodiment, the low-load sub circuit 40 employs the three batteries 11a to 11c located on the positive electrode side of the battery series body 10 as the sub batteries. In the following description, the batteries 11a to 11c are sometimes referred to as the sub batteries 11a to 11c, respectively. The sub batteries 11a to 11c are connected to the flyback converter 42 to supply power to the flyback converter 42.

The flyback converter 42 can transform a voltage. The flyback converter 42 is, for example, a flyback DC/DC converter, and outputs power having a voltage of 12 V. The flyback converter 42 is provided in the low-load sub circuit 40, and includes the primary conversion units 42A, 42B, and 42C, and the secondary conversion unit 42D. The primary conversion units 42A, 42B, and 42C are provided corresponding to the sub batteries 11a, 11b, and 11c, respectively. The respective primary conversion units 42A, 42B, and 42C are arranged in parallel with the secondary conversion unit 42D. The primary conversion units 42A, 42B, and 42C are arranged so as to enable magnetic field coupling with the secondary conversion unit 42D in an isolated state. The primary conversion unit 42A and the secondary conversion unit 42D constitute one DC/DC converter. Similarly, the primary conversion unit 42B and the secondary conversion unit 42D constitute one DC/DC converter, and the primary conversion unit 42C and the secondary conversion unit 42D constitute one DC/DC converter.

The primary conversion unit 42A includes the coil L1 and a FET Q1. The coil L1 has a winding portion wound in a spiral form. The winding portion is arranged so as to enable magnetic field coupling with a winding portion of the secondary conversion unit 42D in an isolated state. The coil L1 is connected to the positive electrode terminal of the sub battery 11a at one end of the winding portion, and to a negative electrode terminal of the sub battery 11a at the other end of the winding portion via the FET Q1. The coil L1 accumulates electric energy according to power supplied from the sub battery 11a.

The FET Q1 is a switching element for supplying or cutting off a current, and is, for example, an N-channel Metal Oxide Semiconductor Field Effect Transistor (MOSFET). The FET Q1 is disposed between the coil L1 and the negative electrode terminal of the sub battery 11a, and includes a drain terminal, a source terminal, and a gate terminal. In the FET Q1, the drain terminal is connected to the other end of the winding portion of the coil L1, the source terminal to the negative electrode terminal of the sub battery 11a, and the gate terminal to the controller 50. The FET Q1 is turned ON/OFF according to a gate voltage applied to the gate terminal by the controller 50, thereby supplying or cutting off a current flowing through the coil L1.

The primary conversion unit 42B is configured similarly to the primary conversion unit 42A described above. That is, the primary conversion unit 42B includes the coil L2 and a FET Q2. The coil L2 has a winding portion wound in a spiral form. The winding portion is arranged so as to enable magnetic field coupling with the winding portion of the secondary conversion unit 42D in an isolated state. The coil L2 is connected to the positive electrode terminal of the sub battery 11b at one end of the winding portion, and to a negative electrode terminal of the sub battery 11b at the other end of the winding portion via the FET Q2. The coil L2 accumulates electric energy according to power supplied from the sub battery 11b.

The FET Q2 is a switching element for supplying or cutting off a current, and is, for example, an N-channel MOSFET. The FET Q2 is disposed between the coil L2 and the negative electrode terminal of the sub battery 11b, and includes a drain terminal, a source terminal, and a gate terminal. In the FET Q2, the drain terminal is connected to the other end of the winding portion of the coil L2, the source terminal to the negative electrode terminal of the sub battery lib, and the gate terminal to the controller 50. The FET Q2 is turned ON/OFF according to a gate voltage applied to the gate terminal by the controller 50, thereby supplying or cutting off a current flowing through the coil L2.

The primary conversion unit 42C is configured similarly to the primary conversion units 42A and 42B described above. That is, the primary conversion unit 42C includes the coil L3 and a FET Q3. The coil L3 has a winding portion wound in a spiral form. The winding portion is arranged so as to enable magnetic field coupling with the winding portion of the secondary conversion unit 42D in an isolated state. The coil L3 is connected to the positive electrode terminal of the sub battery 11c at one end of the winding portion, and to a negative electrode terminal of the sub battery 11c at the other end of the winding portion via the FET Q3. The coil L3 accumulates electric energy according to power supplied from the sub battery 11c.

The FET Q3 is a switching element for supplying or cutting off a current, and is, for example, an N-channel MOSFET. The FET Q3 is disposed between the coil L3 and the negative electrode terminal of the sub battery 11c, and includes a drain terminal, a source terminal, and a gate terminal. In the FET Q3, the drain terminal is connected to the other end of the winding portion of the coil L3, the source terminal to the negative electrode terminal of the sub battery 11c, and the gate terminal to the controller 50. The FET Q3 is turned ON/OFF according to a gate voltage applied to the gate terminal by the controller 50, thereby supplying or cutting off a current flowing through the coil L3.

The secondary conversion unit 42D includes a coil L4 and a FET Q4. The coil L4 has the winding portion wound in a spiral form. The winding portion is arranged so as to enable magnetic field coupling with the winding portions of the primary conversion units 42A, 42B, and 42C in an isolated state. The coil L4 is connected to the first terminal r21 of the low-voltage load portion R2 at one end of the winding portion, and to the second terminal r22 of the low-voltage load portion R2 at the other end of the winding portion via the FET Q4. The coil L4 accumulates electric energy according to power supplied from the primary conversion units 42A, 42B, and 42C, and generates an induced electromotive force by the accumulated electric energy to supply power to the low-voltage load portion R2.

The FET Q4 is a switching element for supplying or cutting off a current, and is, for example, an N-channel MOSFET. The FET Q4 is disposed between the coil L4 and the second terminal r22 of the low-voltage load portion R2, and includes a drain terminal, a source terminal, and a gate terminal. In the FET Q4, the drain terminal is connected to the other end of the winding portion of the coil L4, the source terminal to the second terminal r22 of the low-voltage load portion R2, and the gate terminal to the controller 50. The FET Q4 is turned ON/OFF according to a gate voltage applied to the gate terminal by the controller 50, thereby supplying or cutting off a current flowing through the coil L4.

In the low-load sub circuit 40, the fuse F1 is disposed between the positive electrode terminal of the sub battery 11a and the coil L1 of the primary conversion unit 42A. The fuse F1 blows to protect the circuit when an overcurrent flows to the primary conversion unit 42A from the sub battery 11a. In the low-load sub circuit 40, a fuse F2 is disposed between the positive electrode terminal of the sub battery 11b and the coil L2 of the primary conversion unit 42B. The fuse F2 blows to protect the circuit when an overcurrent flows to the primary conversion unit 42B from the sub battery 11b. In the low-load sub circuit 40, a fuse F3 is disposed between the positive electrode terminal of the sub battery 11c and the coil L3 of the primary conversion unit 42C. The fuse F3 blows to protect the circuit when an overcurrent flows to the primary conversion unit 42C from the sub battery 11c.

The flyback converter 42 transforms the voltage of power supplied from the sub batteries 11a to 11c by turning ON/OFF the FETs Q1 to Q4 in the primary conversion units 42A to 42C and the secondary conversion unit 42D, and supplies the power to at least one of the low-voltage load portion R2 and the main battery 11d. For example, the flyback converter 42 accumulates the electric energy of power supplied from the sub battery 11a in the coils L1 and L4 by turning ON the FET Q1 and turning OFF the FET Q4 in the primary conversion unit 42A and the secondary conversion unit 42D. The flyback converter 42 then turns OFF the FET Q1 and turns ON the FET Q4 to generate an induced electromotive force by the electric energy accumulated in the coils L1 and L4. The flyback converter 42 thereby supplies power having a voltage of 12 V to the low-voltage load portion R2 or the like. With regard to the other primary conversion units 42B and 42C and the secondary conversion unit 42D, the flyback converter 42 operates similarly to the above operation with the primary conversion unit 42A and the secondary conversion unit 42D. That is, the flyback converter 42 accumulates the electric energy of power supplied from the sub battery 11b in the coils L2 and L4 by turning ON the FET Q2 and turning OFF the FET Q4 in the primary conversion unit 42B and the secondary conversion unit 42D. The flyback converter 42 then turns OFF the FET Q2 and turns ON the FET Q4 to generate an induced electromotive force by the electric energy accumulated in the coils L2 and L4. The flyback converter 42 thereby supplies power having a voltage of 12 V to the low-voltage load portion R2 or the like. Similarly, the flyback converter 42 accumulates the electric energy of power supplied from the sub battery 11c in the coils L3 and L4 by turning ON the FET Q3 and turning OFF the FET Q4 in the primary conversion unit 42C and the secondary conversion unit 42D. The flyback converter 42 then turns OFF the FET Q3 and turns ON the FET Q4 to generate an induced electromotive force by the electric energy accumulated in the coils L3 and L4. The flyback converter 42 thereby supplies power having a voltage of 12 V to the low-voltage load portion R2 or the like.

The controller 50 controls the flyback converter 42. The controller 50 includes an electronic circuit mainly composed of a known microcomputer including a CPU, a ROM and a RAM constituting a memory, and an interface. The controller 50 detects abnormalities of the batteries 11a to 11d based on the detection values of the battery voltages, the battery currents or the like outputted from the battery management systems or the cell voltage sensors provided in the batteries 11a to 11d. If the main battery 11d is short-circuited, the fuse F4 blows to cause no current to flow to the low-voltage load portion R2 from the main battery 11d, making the current value of the current sensor 31 abnormal. The controller 50 thereby detects an abnormality of the main battery 11d. If an ON-fixation failure occurs in the primary conversion unit 42A with the FET Q1 fixed in an ON state and not turned OFF, the fuse F1 blows to cause no current to flow to the primary conversion unit 42A from the sub battery 11a, making the current value of the current sensor 41a abnormal. The controller 50 thereby detects an abnormality of the primary conversion unit 42A. With regard to the other primary conversion units 42B and 42C, the controller 50 detects ON-fixation failures of the FETs Q2 and Q3 similarly to the primary conversion unit 42A. If an OFF-fixation failure occurs in the primary conversion unit 42A with the FET Q1 fixed in an OFF state and not turned ON, no current flows to the primary conversion unit 42A from the sub battery 11a, making the current value of the current sensor 41a abnormal. The controller 50 thereby detects the abnormality of the primary conversion unit 42A. With regard to the other primary conversion units 42B and 42C, the controller 50 detects OFF-fixation failures of the FETs Q2 and Q3 similarly to the primary conversion unit 42A. The controller 50 detects an abnormality of the battery series body 10 based on the current value of the battery series body 10 outputted from the current sensor 21.

The controller 50 controls the flyback converter 42 according to a normal mode, a sub battery power consumption mode, and an abnormal mode. The normal mode is a mode in which the low-load main circuit 30 supplies power to the low-voltage load portion R2 by preferentially using the main battery 11d when the low-load main circuit 30 and the low-load sub circuit 40 are normal. The normal mode is a mode executed mainly when the low-load main circuit 30 and the low-load sub circuit 40 are normal. In the normal mode, the main battery 11d of the low-load main circuit 30 having smaller resistance and higher power transmission efficiency than those of the low-load sub circuit 40 is preferentially used. In the normal mode, the controller 50 supplies power to the low-voltage load portion R2 via the low-load main circuit 30 having relatively high power transmission efficiency as illustrated in FIG. 2. At this time, the battery series body 10 supplies power to the high-voltage load portion R1.

The sub battery power consumption mode is a mode in which the low-load sub circuit 40 supplies power to the low-voltage load portion R2 by preferentially using the sub batteries 11a to 11c when the low-load main circuit 30 and the low-load sub circuit 40 are normal. The sub battery power consumption mode is a mode executed, for example, when equalization is performed by balancing charge amounts among the batteries 11. For instance, when the sub batteries 11a to 11c have a larger charge amount than the main battery 11d, the controller 50 supplies power to at least one of the low-voltage load portion R2 and the main battery 11d from the sub batteries 11a to 11c to perform equalization by preferentially using the low-load sub circuit 40 over the low-load main circuit 30 in the sub battery power consumption mode. The controller 50 may also supply power to at least one of the low-voltage load portion R2 and the main battery 11d from the sub batteries 11a to 11c in a process other than the equalization in the sub battery power consumption mode. Note that the controller 50 may control the flyback converter 42 to balance the charge amounts and perform the equalization by temporarily moving the charged power of the sub battery 11a having a large charge amount to the main battery 11d, and moving the charged power moved to the main battery 11d, to the sub battery 11c having a small charge amount.

The abnormal mode is a mode in which the low-load sub circuit 40 supplies power to the low-voltage load portion R2 when the low-load main circuit 30 is abnormal and the low-load sub circuit 40 is normal. The abnormal mode is a mode executed when a failure occurs in the main battery 11d to make the low-load main circuit 30 abnormal. For example, in the abnormal mode, the controller 50 controls driving of the flyback converter 42 to supply power to the low-voltage load portion R2 via the flyback converter 42 from the sub batteries 11a to 11c as illustrated in FIG. 3. At this time, since a failure occurs in the main battery 11d, the battery series body 10 cannot supply power to the high-voltage load portion R1.

In the abnormal mode in which the main battery 11d is abnormal, the controller 50 controls driving of all the normal primary conversion units 42A to 42C to supply power to the low-voltage load portion R2 via the respective primary conversion units 42A to 42C from the corresponding sub batteries 11a to 11c. The respective sub batteries 11a to 11c thereby jointly supply the power required for the low-voltage load portion R2. In this case, the controller 50 causes the respective sub batteries 11a to 11c to jointly supply the power required for the low-voltage load portion R2 by, for example, supplying the same amount of power (⅓ of the power required for the low-voltage load portion R2) to the low-voltage load portion R2.

In the abnormal mode in which the main battery 11d is abnormal and some of the primary conversion units 42A to 42C are abnormal, the controller 50 controls driving of the normal primary conversion units 42A to 42C to supply power to the low-voltage load portion R2 via the normal primary conversion units 42A to 42C from the sub batteries 11a to 11c. When the current value of the battery series body 10 outputted from the current sensor 21 is abnormal, no power is supplied to the high-voltage load portion R1.

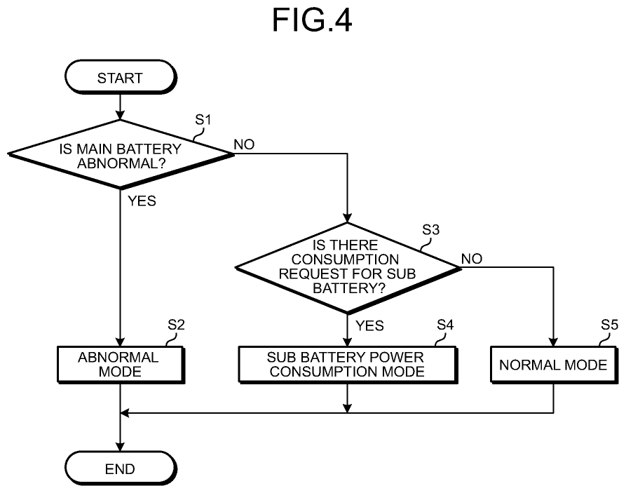

Next, an operation example of the multi-output power supply device 1 will be described. FIG. 4 is a flowchart illustrating the operation example of the multi-output power supply device 1 according to the embodiment. In the multi-output power supply device 1, the controller 50 determines whether the main battery 11d is abnormal (step S1). For example, when the main battery 11d is short-circuited, the current value of the current sensor 31 becomes an abnormal value. The controller 50 thereby detects the abnormality of the main battery 11d. When the main battery 11d is abnormal (Yes at the step S1), the controller 50 shifts the mode to the abnormal mode in which the low-load sub circuit 40 supplies power to the low-voltage load portion R2 (step S2). For instance, in the abnormal mode, the controller 50 controls the driving of the flyback converter 42 to supply power to the low-voltage load portion R2 via the flyback converter 42 from the sub batteries 11a to 11c (see FIG. 3). When the main battery 11d is normal (No at the step S1), the controller 50 determines whether there is a consumption request for the sub batteries 11a to 11c (step S3). When the consumption request for the sub batteries 11a to 11c is detected (Yes at the step S3), the controller 50 shifts the mode to the sub battery power consumption mode in which the low-load sub circuit 40 supplies power to the low-voltage load portion R2 by preferentially using the sub batteries 11a to 11c (step S4). For example, in the sub battery power consumption mode, the controller 50 performs the equalization by supplying power to at least one of the low-voltage load portion R2 and the main battery 11d from the sub batteries 11a to 11c. When no consumption request for the sub batteries 11a to 11c is detected (No at the step S3), the controller 50 shifts the mode to the normal mode in which the low-load main circuit 30 supplies power to the low-voltage load portion R2 by preferentially using the main battery 11d (step S5). For instance, in the normal mode, the controller 50 supplies power to the low-voltage load portion R2 via the low-load main circuit 30 having relatively high power transmission efficiency (see FIG. 2).

As described above, the multi-output power supply device 1 according to the embodiment includes the battery series body 10, the high-load main circuit 20, the low-load main circuit 30, the low-load sub circuit 40, and the controller 50. The battery series body 10 is obtained by connecting the batteries 11 in series. The high-load main circuit 20 supplies power to the high-voltage load portion R1 from the battery series body 10. The low-load main circuit 30 employs at least one of the batteries 11 constituting the battery series body 10 as the main battery 11d, and supplies power to the low-voltage load portion R2 whose drive voltage is lower than the high-voltage load portion R1, from the main battery 11d. The low-load sub circuit 40 employs the batteries 11 different from the main battery 11d as the sub batteries 11a to 11c out of the batteries 11 constituting the battery series body 10, and supplies power to the low-voltage load portion R2 from the sub batteries 11a to 11c. The flyback converter 42 is the converter provided in the low-load sub circuit 40 and capable of transforming a voltage. The controller 50 controls the driving of the flyback converter 42 to supply power to the low-voltage load portion R2 via the flyback converter 42 from the sub batteries 11a to 11c when the main battery 11d is abnormal.

Such a configuration enables the multi-output power supply device 1 to supply the power adjusted by the flyback converter 42 to the low-voltage load portion R2 from the sub batteries 11a to 11c even when the main battery 11d is abnormal. Suppose that the low-voltage load portion R2 is an important load portion such as the vehicle control ECU and the automated driving ECU. In this case, even when the main battery 11d is abnormal, the multi-output power supply device 1 can keep supplying power to the important load portion. As a result, the reliability (redundancy) of the power supply can be improved.

In the above multi-output power supply device 1, the primary conversion units 42A to 42C and the sub batteries 11a to 11c are provided in a plural number. The primary conversion units 42A to 42C are provided corresponding to the sub batteries 11a to 11c, respectively. When the main battery 11d is abnormal and some of the primary conversion units 42A to 42C are abnormal, the controller 50 controls the driving of the normal primary conversion units 42A to 42C to supply power to the low-voltage load portion R2 via the normal primary conversion units 42A to 42C from the sub batteries 11a to 11c. Such a configuration enables the multi-output power supply device 1 to supply power to the low-voltage load portion R2 even when the main battery 11d and some of the primary conversion units 42A to 42C are abnormal. As a result, the reliability of the power supply can be further improved.

In the above multi-output power supply device 1, when the main battery 11d is abnormal, the controller 50 controls the driving of all the normal primary conversion units 42A to 42C to supply power to the low-voltage load portion R2 via the respective primary conversion units 42A to 42C from the corresponding sub batteries 11a to 11c. The respective sub batteries 11a to 11c thereby jointly supply the power required for the low-voltage load portion R2. Such a configuration enables the multi-output power supply device 1 to output the power required for the low-voltage load portion R2 with the primary conversion units 42A to 42C jointly supplying the power. Consequently, loads on the respective primary conversion units 42A to 42C can be reduced, and the primary conversion units 42A to 42C can be prevented from malfunctioning.

In the above multi-output power supply device 1, the controller 50 controls the flyback converter 42 according to the normal mode in which the low-load main circuit 30 supplies power to the low-voltage load portion R2 by preferentially using the main battery 11d when the low-load main circuit 30 and the low-load sub circuit 40 are normal, the sub battery power consumption mode in which the low-load sub circuit 40 supplies power to the low-voltage load portion R2 by preferentially using the sub batteries 11a to 11c when the low-load main circuit 30 and the low-load sub circuit 40 are normal, and the abnormal mode in which the low-load sub circuit 40 supplies power to the low-voltage load portion R2 when the low-load main circuit 30 is abnormal and the low-load sub circuit 40 is normal. Such a configuration enables the multi-output power supply device 1 to supply power to the low-voltage load portion R2 as appropriate according to each mode.

Modification

While the example in which the primary conversion units 42A to 42C and the sub batteries 11a to 11c are provided in a plural number has been described in the above description, the present invention is not limited thereto. One primary conversion unit and one sub battery may be provided.

While the example in which the controller 50 controls the driving of all the normal primary conversion units 42A to 42C, allowing the respective sub batteries 11a to 11c to jointly supply the power required for the low-voltage load portion R2 when the main battery 11d is abnormal has been described, the present invention is not limited thereto. The controller 50 may control the driving of some of the normal primary conversion units 42A to 42C, and some of the sub batteries 11a to 11c may jointly supply the power required for the low-voltage load portion R2.

While the example in which the multi-output power supply device 1 supplies power to the high-voltage load portion R1 using 48 V power and the low-voltage load portion R2 using 12 V power has been described, the multi-output power supply device 1 may also supply power to load portions of other voltages that differ from each other, in addition to the load portions using 48 V power and 12 V power.

While the example in which the flyback converter 42 includes the three primary conversion units 42A to 42C has been described, the present invention is not limited thereto. The flyback converter 42 may include a different number of primary conversion units.

While the example in which the batteries 11 include the four batteries 11 has been described, the present invention is not limited thereto. The batteries 11 may include a different number of batteries. For the batteries 11, the example in which the sub batteries 11a to 11c have a voltage of 12 V has been described. However, the sub batteries 11a to 11c are not limited to this voltage, and may have another voltage.

While the example in which the multi-output power supply device 1 controls the flyback converter 42 according to the normal mode, the abnormal mode, and the sub battery power consumption mode has been described, the present invention is not limited thereto. The multi-output power supply device 1 may control the flyback converter 42 according to another mode.

While the example in which the Hall current sensor or the shunt current sensor is used as the current sensors 21 and 41a to 41c has been described, the current sensors 21 and 41a to 41c are not limited to these current sensors, and another current sensor may be used.

While the example in which the FETs Q1 to Q4 are the N-channel MOSFETs has been described, the FETs Q1 to Q4 are not limited to the N-channel MOSFET and may be, for instance, another switching element such as a P-channel MOSFET.

The multi-output power supply device according to the present embodiment controls the driving of the DC/DC converter to supply power to the low-voltage load portion via the DC/DC converter from the sub battery when the main battery is abnormal. Consequently, the reliability can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multi-output power supply device comprising:
a battery series body in which a plurality of batteries are connected in series;
a high-load main circuit configured to supply power to a high-voltage load portion from the battery series body;
a low-load main circuit configured to supply power to a low-voltage load portion, a drive voltage of which is lower than the high-voltage load portion, from a main battery by employing at least one of the batteries constituting the battery series body as the main battery;
a low-load sub circuit configured to supply power to the low-voltage load portion from a sub battery by employing a battery different from the main battery as the sub battery out of the batteries constituting the battery series body;
a DC/DC converter provided in the low-load sub circuit and capable of transforming a voltage; and
a controller configured to control the DC/DC converter, wherein
the controller controls driving of the DC/DC converter to supply power to the low-voltage load portion via the DC/DC converter from the sub battery when the main battery is abnormal.

2. The multi-output power supply device according to claim 1, wherein
a plurality of the DC/DC converters and a plurality of the sub batteries are provided,
the DC/DC converters are provided corresponding to the respective sub batteries, and
when the main battery is abnormal and some of the DC/DC converters are abnormal, the controller controls driving of the normal DC/DC converter to supply power to the low-voltage load portion via the normal DC/DC converter from the sub battery.

3. The multi-output power supply device according to claim 1, wherein
a plurality of the DC/DC converters and a plurality of the sub batteries are provided,
the DC/DC converters are provided corresponding to the respective sub batteries, and
when the main battery is abnormal, the controller controls driving of all the normal DC/DC converters to supply power to the low-voltage load portion via the respective DC/DC converters from the corresponding sub batteries, allowing the respective sub batteries to jointly supply power required for the low-voltage load portion.

4. The multi-output power supply device according to claim 2, wherein
a plurality of the DC/DC converters and a plurality of the sub batteries are provided,
the DC/DC converters are provided corresponding to the respective sub batteries, and
when the main battery is abnormal, the controller controls driving of all the normal DC/DC converters to supply power to the low-voltage load portion via the respective DC/DC converters from the corresponding sub batteries, allowing the respective sub batteries to jointly supply power required for the low-voltage load portion.

5. The multi-output power supply device according to claim 1, wherein
the controller controls the DC/DC converter according to a normal mode in which the low-load main circuit supplies power to the low-voltage load portion by preferentially using the main battery when the low-load main circuit and the low-load sub circuit are normal, a sub battery power consumption mode in which the low-load sub circuit supplies power to the low-voltage load portion by preferentially using the sub battery when the low-load main circuit and the low-load sub circuit are normal, and an abnormal mode in which the low-load sub circuit supplies power to the low-voltage load portion when the low-load main circuit is abnormal and the low-load sub circuit is normal.

6. The multi-output power supply device according to claim 2, wherein
the controller controls the DC/DC converter according to a normal mode in which the low-load main circuit supplies power to the low-voltage load portion by preferentially using the main battery when the low-load main circuit and the low-load sub circuit are normal, a sub battery power consumption mode in which the low-load sub circuit supplies power to the low-voltage load portion by preferentially using the sub battery when the low-load main circuit and the low-load sub circuit are normal, and an abnormal mode in which the low-load sub circuit supplies power to the low-voltage load portion when the low-load main circuit is abnormal and the low-load sub circuit is normal.

7. The multi-output power supply device according to claim 3, wherein
the controller controls the DC/DC converter according to a normal mode in which the low-load main circuit supplies power to the low-voltage load portion by preferentially using the main battery when the low-load main circuit and the low-load sub circuit are normal, a sub battery power consumption mode in which the low-load sub circuit supplies power to the low-voltage load portion by preferentially using the sub battery when the low-load main circuit and the low-load sub circuit are normal, and an abnormal mode in which the low-load sub circuit supplies power to the low-voltage load portion when the low-load main circuit is abnormal and the low-load sub circuit is normal.
